(19) United States
(12) Patent Application Publication
(10) Pub. No.: US 2015/0367302 A1
(43) Pub. Date: Dec. 24, 2015

(54) MAGNETIC AGITATOR MIXING SYSTEM AND AN AGITATOR MIXING STAND

(71) Applicant: GE HEALTHCARE BIO-SCIENCES AB, Uppsala (SE)

(72) Inventor: Klaus GEBAUER, Uppsala (SE)

(21) Appl. No.: 14/762,862

(22) PCT Filed: Jan. 21, 2014
(86) PCT No.: PCT/SE2014/050063

§ 371 Date: Jul. 23, 2015

(30) Foreign Application Priority Data
Jan. 23, 2013 (SE) 1350071-5

(51) Int. Cl. B01F 13/08

(52) U.S. Cl. CPC B01F 13/0818; B01F 2215/0032

(57) ABSTRACT

A magnetic agitator mixing system comprising: a first magnetic coupling part, a first driving means provided with a second magnetic coupling part, and a container which is substantially enclosing the first magnetic coupling part. The first magnetic coupling part is rotatably suspended in a stand, which is arranged to rest on an inner surface of the container and a first impeller is arranged to be driven by the first magnetic coupling part. The invention also relates to an agitator mixing stand.

### TECHNICAL FIELD

Embodiments of the present invention relate to a magnetic agitator mixing system and an agitator mixing stand.

### BACKGROUND

Mixers are used for mixing pharmaceutical solutions and suspensions in order to achieve a satisfactory yield and to ensure a uniform distribution of ingredients in a final pharmaceutical product.

Chemical mixing systems often include an agitator or impeller mechanically connected to a drive shaft lowered into a fluid through an opening in the top of a vessel. The drive shaft is connected to an electric motor arranged outside the vessel. In a closed vessel, a fluid seal is provided between the drive shaft and the wall of the vessel to prevent leakage of fluid from the vessel. Other mixing systems include a rotating magnetic drive head outside of the vessel and a rotating magnetic impeller as an agitation element within the vessel. The movement of the magnetic drive head enables torque transfer and thus rotation of the magnetic impeller allowing the impeller to mix and agitate the fluid within the vessel. Because there is no need in a closed vessel to have a drive shaft penetrate the vessel wall to mechanically rotate the impeller, magnetically coupled systems can eliminate the need for having fluid seals between the drive shaft and the vessel. Magnetic coupling of an impeller inside the vessel to a drive system or motor external to the vessel can eliminate contamination issues, allow for a completely enclosed system, and prevent leakage.

Increasingly, in the biopharmaceutical industry, single use or disposable containers or vessels are used. Such containers can be flexible or collapsible plastic bags that are supported by an outer rigid structure such as a stainless steel shell. Use of sterilized disposable bags eliminates time consuming steps of cleaning of the vessel and reduces the chance of contamination. Combining the single use or disposable bags with a magnetic agitator system establishes a sterile environment that is especially important for biopharmaceutical manufacturing. A variety of vessels, devices, components and unit operations for manipulating liquids and/or for carrying out biochemical and/or biological processes are available. For instance, biological materials (e.g., animal and plant cells) including, for example, mammalian, plant or insect cells and microbial cultures can be processed using bioreactors that include single-use processing bags. Such bags will in manufacturing scale bioprocessing have volumes up to several cubic meters and, accordingly, diameters up to about 2 m. The bags are typically supplied presterilized and folded for placement in a stainless steel shell, where they are raised and filled such that the bag wall forms a liner on the inside of the shell. Manufacturing of complex biological products such as proteins, monoclonal antibodies, etc. requires, in many instances, multiple processing steps ranging from fermentation or cell culture (bacteria, yeast, insect, fungi, etc.), to primary recovery and purification. Conventional bioreactor-based manufacturing of biological products generally utilizes batch, or fed-batch processing, or continuous or perfusion mode processing with subsequent off-line laboratory analysis conducted on representative samples collected from various points of the process to ensure quality.

Magnetic agitator systems currently include particular components to both retain the magnetic agitating element in a certain position within the flexible bag during mixing, and also to maintain coupling and proper alignment between the magnetic agitator and the external magnetic drive head or system. Examples of such components include post or cup like receiver structures that are formed as part of the disposable container, typically as part of a rigid bottom or base of a disposable bag.

The magnets in the external drive head and in the impeller must be orientated and coupled together for proper function of the mixing system. Two different orientations of the impeller magnets and external driver magnets are commonly used. The two orientations are axial and radial. Axial orientation generally means that the direction of the magnetic coupling between the internal and external rotating components is parallel to the axis around which the internal and external components are rotating. The terms radial and radial orientation mean that the direction of the magnetic coupling between the internal and external rotating components is at an angle that is not parallel to axis of rotation, e.g., perpendicular to the axis around which the internal and external components are rotating or some intermediate angle greater than 0 degrees and less than 90 degrees relative to the axis of rotation.

In an axially coupled magnetic coupling system the direction of the coupling and de-coupling force is parallel to the direction of the magnetic coupling force. If the nonlinear attractive force between the internal and the external system components during coupling cannot be adequately controlled, the internal and external components can forcefully slam together, damaging the components and the vessel. Conversely, the force required to separate the internal and external components could damage the components by overstressing the components during de-coupling as the components are pulled apart. This is especially true for the coupling components of a disposable system wherein at least some of the components might be constructed from plastic.

In a radially coupled magnetic coupling system, the nonlinear attractive forces between the internal and external components must also be overcome in a controlled manner when the components approach one other during coupling and as they recede from one other during de-coupling. In the case of a radially coupled system, the forces during coupling and de-coupling would result in what could be called a shearing force; that is, the direction of the force would be perpendicular to the magnetic coupling. If the nonlinear attractive force between the internal and the external system components during coupling cannot be adequately controlled the internal and external components can forcefully slam together on one side of the system, resulting in non-alignment of the coupling components and damaging the components and the vessel. Conversely, during de-coupling when the internal and external components separate, the components could again slam together in a sideways motion and this could damage the components and the vessel. Again, this is especially true for the coupling components of a disposable system wherein at least some of the components are plastic materials.

Misalignment of the driver and impeller magnets can lead to complete decoupling and the ejection of the impeller into the fluid volume of the vessel. Unless the impeller can be re-coupled to the drive mechanism, no further mixing can be accomplished and the batch may be compromised in an attempt to reseat the impeller or, failing successful re-coupling, the entire batch being processed must be discarded. The possibility of de-coupling increases with the height of the impeller. In large vessels, it can be desirable to have the impeller to have an axial shaft that extends for a substantial portion, if not the entire height, of the container and carries several separate sets of vanes, for example, to mix the top, middle and bottom of the fluid column in the container simultaneously. Because the center of gravity for such extended length agitators is at a distance from the impeller, misalignment can quickly lead to wobbling and, ultimately, detachment especially at high rotational speeds, and the impeller and vanes may forcefully slam into the vessel wall and damaging the components and the vessel.

Document US-A1-2007/0030759 discloses a system comprising a rotating mixing element for pumping or mixing fluids using a rotatable magnetic element levitated in a vessel. U.S. Pat. No. 4,162,855, US20070165485 and DE102006014471A1 disclose small-scale mixing systems comprising a suspended rotatable magnetic element.

### SUMMARY OF THE INVENTION

Notwithstanding the existence of such prior art magnetic agitator mixing systems, there is a need for simpler, less expensive, more efficient and more reliable magnetic agitation mixer systems for biopharmaceutical manufacturing.

Embodiments of the present invention increase the reliability of a magnetic agitator mixing system.

Embodiments of the present invention increase the efficiency of magnetic agitator mixing system.

Embodiments of the present invention reduce complexity of a magnetic agitator mixing system.

Embodiments of the present invention reduce cost when manufacturing a magnetic agitator mixing system.

According to an embodiment of the present invention, there is provided a magnetic agitator mixing system. The magnetic agitator mixing system comprising a first magnetic coupling part; a first driver comprising a second magnetic coupling part; and a container substantially enclosing the first magnetic coupling part, wherein the first magnetic coupling part is rotatably suspended in a stand arranged to rest on an inner surface of the container, and a first impeller in the first magnetic coupling part is arranged to be driven by the first magnetic coupling part.

According to another embodiment of the present invention, there is provided an agitator mixing stand. The agitator mixing stand comprising a first magnetic coupling part rotatably arranged at the stand, wherein the first magnetic coupling part is rotatably suspended in the stand, and the stand is arranged to rest on an inner surface of a container.

Such magnetic agitator mixing system and agitator mixing stand according to embodiments of the present invention eliminates or minimizes the possibility of vessel failure by avoiding the rotating impeller element to come in contact with a portion of the vessel structure. Therefore, the reliability of the magnetic agitator mixing system provided with the agitator mixing stand according to embodiments of the invention will increase.

Embodiments of the present invention provide several improvements over existing magnetic agitation mixing systems for use with for example a bioreactor comprising a container. The magnetic agitator mixing system provided with the agitator mixing stand according to embodiments of the invention eliminates the need for post or cup like receiver structures that are formed as part of the disposable container, typically as part of a rigid bottom or base of a disposable bag. This will increase the reliability and reduce complexity of the magnetic agitator mixing system provided with the agitator mixing stand. As a result also the manufacturing cost will be reduced.

Embodiments of the present invention accordingly comprises a magnetic agitator mixing system and an agitator mixing stand, the features of construction, combination of elements, and arrangement of parts that will be exemplified in the description set forth hereinafter and the scope of the invention will be indicated in the claims. The principles and features of this invention may be employed in various and numerous embodiments without departing from the scope of the invention.

### BRIEF DESCRIPTION OF THE DRAWINGS

Further aspects, advantages and features of the invention can be derived from the following detailed description of exemplary embodiments of the invention, with reference to the drawings.

FIG. 1 shows a section view of a first embodiment of a magnetic agitator mixing system according to the present invention,

FIG. 2 shows a section view along line II-II in FIG. 1,

FIG. 3 shows a section view of a second embodiment of a magnetic agitator mixing system according to the present invention,

FIG. 4 shows a section view of a third embodiment of a magnetic agitator mixing system according to the present invention,

FIG. 5 shows a section view of a fourth embodiment of a magnetic agitator mixing system according to the present invention,

FIG. 6 shows a section view of a fifth embodiment of a magnetic agitator mixing system according to the present invention,

FIG. 7 shows a section view along line VII-VII in FIG. 6, and

FIG. 8 shows a section view of a sixth embodiment of a magnetic agitator mixing system according to the present invention.

### DETAILED DESCRIPTION

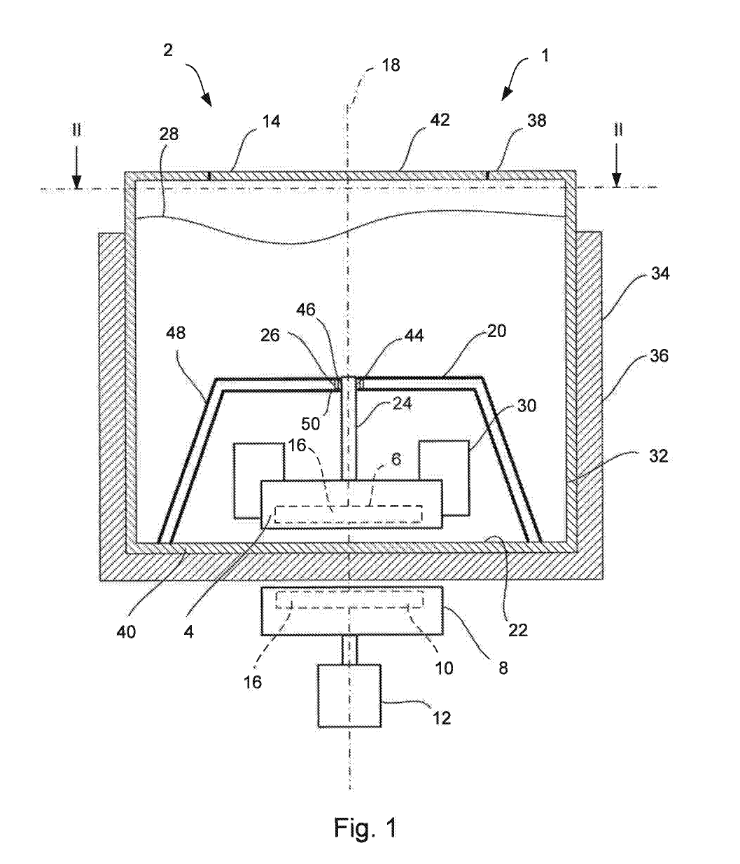

FIG. 1 shows a section view of a first embodiment of a magnetic agitator mixing system 1 according to the present invention. The magnetic agitator mixing system 1 comprises a first impeller 4 provided with a first magnetic coupling part 6 and a first driving means 8 provided with a second magnetic coupling part 10. A first motor 12 is connected to the first driving means 8 for rotating the first impeller 4 via the first and second magnetic coupling parts 6, 10. The first impeller 4 and the first magnetic coupling part 6 are substantially enclosed within a container 14, which may be a bioreactor.

The first and second coupling parts 6, 10 comprise permanent magnets 16. The magnetic flux between the first and second magnetic coupling parts 6, 10 causes rotation of the first magnetic coupling 6 part when the first motor 12 brings the second magnetic coupling part 10 to rotate. In an embodiment, the magnets 16 bring to levitate the first and second coupling parts 6, 10 by means of a repulsive levitation force.

Two different orientations of the magnets 16 in the first and second coupling parts 6, 10 may be used. The two orientations are axial and radial. Axial orientation generally means that the direction of the magnetic coupling between the first and second coupling parts 6, 10 is parallel to the axis 18 around which the first and second coupling parts 6, 10 are rotating. The terms radial and radial orientation means that the direction of the magnetic coupling between the first and second coupling parts 6, 10 is at an angle that is not parallel to axis 18 of rotation. However, the magnetic coupling can be in a direction that is neither strictly axial nor strictly radial. One advantage of this quasi-radial angular coupling is better control of coupling and de-coupling forces during the actual coupling and decoupling of the magnetic coupling parts 6, 10. The selection of a particular magnetic coupling angle chosen from a range of angles between those defined as strictly axial or strictly radial allow the coupling and de-coupling for a system to be better and more precisely controlled. This is because for angles between that defined as strictly axial and strictly radial, a blend of perpendicular and parallel magnetic forces with respect to the direction of relative movement of the first and second coupling parts 6, 10 would come into play. The selection of a quasi-radial coupling angle can also place the first impeller 4 in a more stable rotational configuration than either a strictly axial or strictly radial configuration would provide.

The first impeller 4 is rotatably suspended in a stand 20, which is arranged to rest on an inner surface 22 of the container 14. The first impeller 4 is rotatably suspended in the stand 20 by means of a first shaft 24. The first shaft 24 is rotatable connected to the stand 20 by means of a bearing 26. Thus, the rotation of the second magnetic coupling part 10 by means of the first motor 12 causes rotation of the first coupling part 6 and the first impeller 4 and thus enabling agitation and mixing of a fluid 28 within the container 14 by the rotating first impeller 4. The first impeller 4 comprises at least one vane 30 or blade. In FIG. 1 two vanes 30 are arranged substantially symmetrically on the first impeller 4. The stand 20, first shaft 24 and first impeller 4 have such dimensions that the stand 20 spacing the rotating first impeller 4 away from the wall 32 of the container 14. The agitator mixing stand 20, first shaft 24, bearing 26 and first impeller 4 are together with the first magnetic coupling part 6 disposable in the container 14 after the fluid has been evacuated from the container 14.

The container 14 may be flexible and be configured to be supported by a container support structure 34 including a container support structure wall 36 that at least partially surrounds, supports or contains the container 14 during use. The container 14 has an upper portion 38 and a lower portion 40. In the upper portion 38 a closable opening may be arranged for filling and evacuating the container 14 with fluid 28 and also for entering the stand 20 into the container 14 together with its components. The container 14 may be any of a flexible or collapsible bag, a semi-rigid vessel, and any other containment vessel capable of receiving and holding or containing a fluid 28.

The container 14 may be a vessel having at least one wall 32 that is flexible and/or at least one wall 32 that is rigid or semi-rigid. The stand 20 may be attached to a rigid or semi-rigid wall 32, e.g. by welding. The rigid or semi-rigid wall may be a bottom wall or a top wall of the container 14 during use. The inner volume of the container may be at least 0.1 m³, such as at least 0.5 m³, in which case a firm attachment of the stand to a rigid or a semi-rigid wall is highly advantageous for the stability of the system.

The bearing 26 arranged between the stand 20 and the first shaft 24 provides a raceway 44, or part of a raceway to ensure low friction rotation of the first impeller 4. For example the first shaft 24 can include a concave groove 46 that encircles the peripheral surface of the first shaft 24 and the stand 20 can likewise include a similar concave raceway 44 facing the raceway 44 at the first shaft 24 such that ball bearings or the like can be loaded between the two raceways 44 to provide a raceway bearing. Other types of bearings, such as fluid bearings and slide bearings are also possible to arrange between the first shaft 24 and the stand 20. Also, it may be possible to arrange the bearing 26 between the first shaft 24 and the first impeller 4, so that the first impeller 4 rotates relative to the first shaft 24, which is firmly attached to the stand 20.

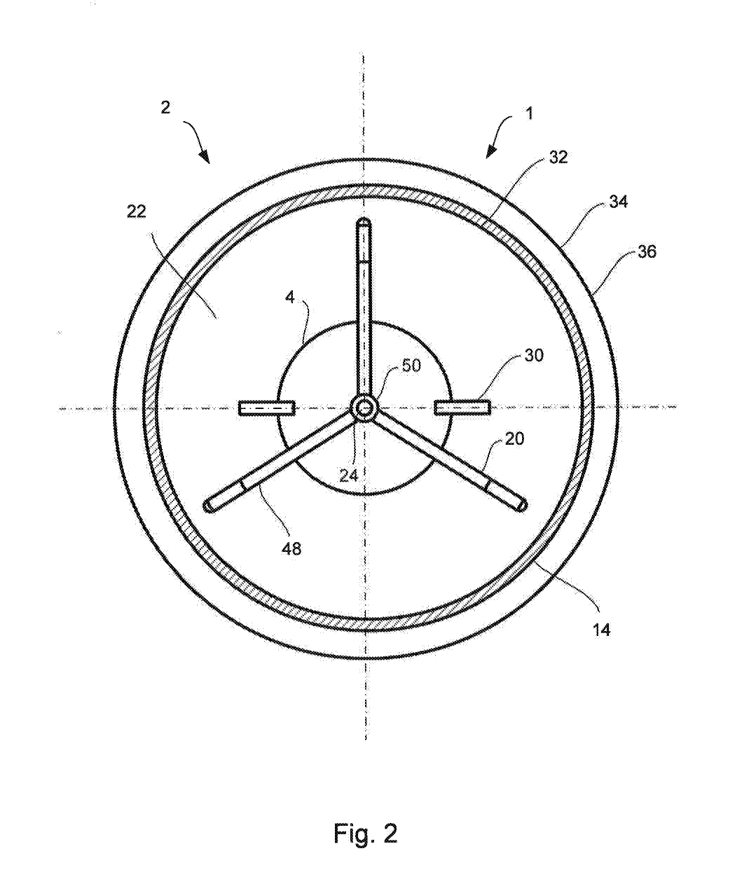

FIG. 2 shows a section view along line II-II in FIG. 1. According to an embodiment, the stand 20 comprises three legs 48 arranged substantially symmetrically as a tripod, which legs 48 rest on the inner surface 22 of the container 14. The stand 20 may however be provided with more than three legs 48, which are arranged to rest on the inner surface 22 of the container 14. The legs 48 are connected to a hub 50 in which the bearing 26 for the first shaft 24 is arranged. In an embodiment, the hub 50 is sealed so that the fluid 28 may not came into contact with the bearing 26. In an embodiment, the stand 20 is made by a disposable material such as plastic, or alternatively metal. In an embodiment, the legs 48 are rigid. As used herein, the term “rigid” refers to a structure that does not bend easily or is less flexible than a structure that is described as “flexible,” and is intended to encompass rigid and semi-rigid, solid, hollow or composite structures of various geometric shapes, e.g., cylindrical, tubular or tapered shapes. A rigid rod can be somewhat flexible and, in some applications, the ability to flex to some extent may be desirable. The key requirement of the legs 48 is that it has sufficient mechanical integrity to constrain forces and movements of the first impeller 4 and the first shaft 24 and prevent the first impeller 4 to slam into the wall 32 of the container 14 if the container 14 is subjected to external forces which by accident would move the stand 20 and its components within the container 14.

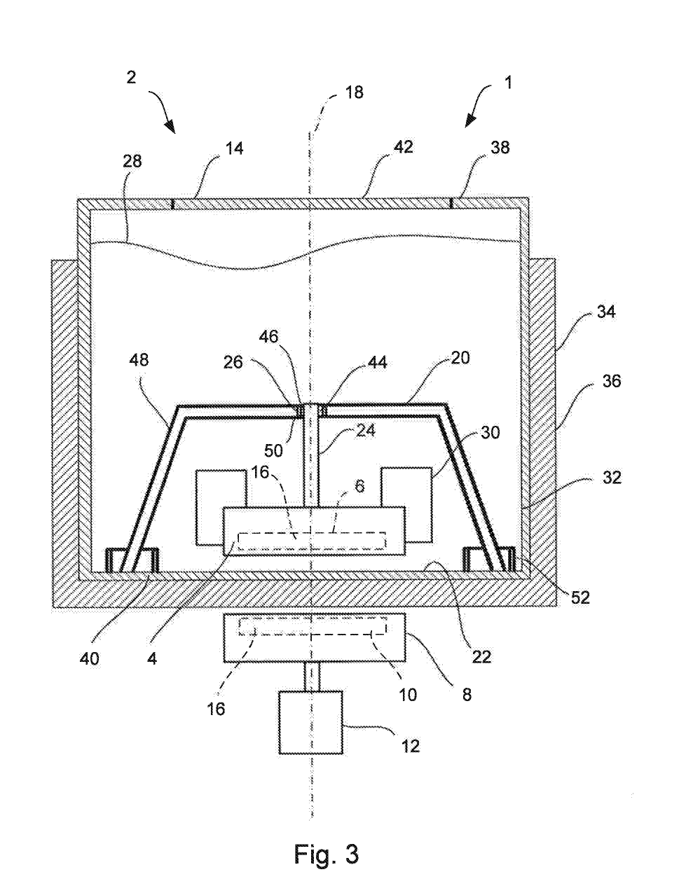

FIG. 3 shows a section view of a second embodiment of a magnetic agitator mixing system 1 according to the present invention. According to the second embodiment the inner surface 22 of the container 14 is provided with receiver means 52 for fixating the legs 48 of the stand 20, so that the stand 20 will rest even more stable on the inner surface 22 of the container 14. In an embodiment, a receiver means 52 is provided for each leg 48 of the stand 20. The receiver means 52 may be welded or permanently connected to the inner surface 22 of the wall 32 of the container 14, at the upper or lower portions 38, 40 or at the inner surface 22 of the wall 32 of the container 14 of the container portion there between.

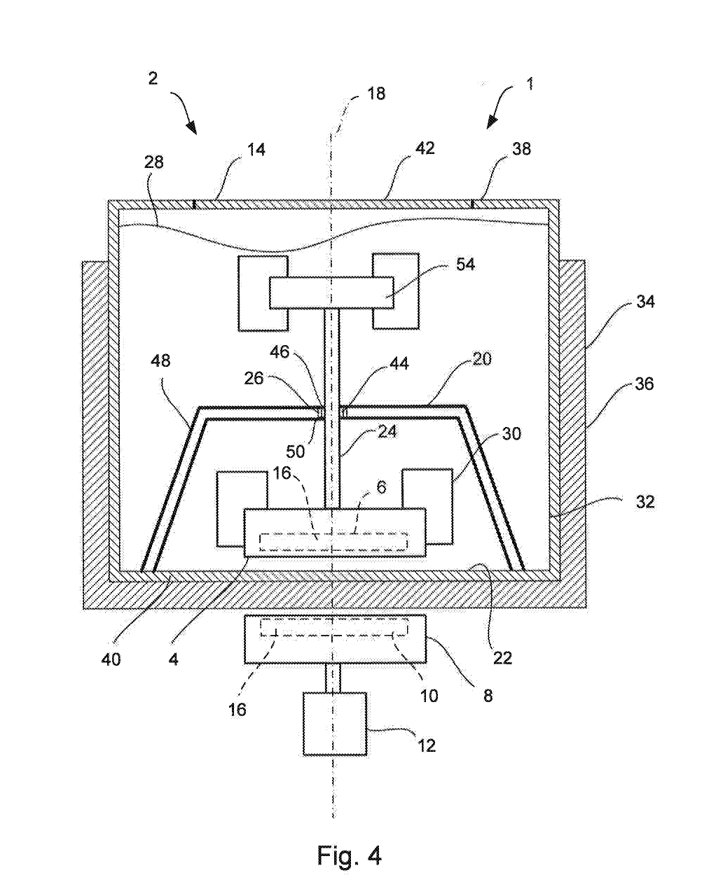

FIG. 4 shows a section view of a third embodiment of a magnetic agitator mixing system 1 according to the present invention. According to the third embodiment a second impeller 54 is connected to the first shaft 24. However, a number of impellers could be arranged at different intervals along the first shaft 24. Arranging a second impeller 54 to the first shaft 24 will increase the effect of agitating and mixing the fluid 28. The third embodiment is especially favorable if the container 14 has large dimensions and an essentially high. The first and second impellers 4, 54 would thereby reach and cover a large volume of the container 14. In order to stabilise the first shaft 24 a further stand 56 may be arranged in the container 14 and the first shaft 24 may be rotatably connected to the further stand 56. If suitable, the first impeller 4 may in the third embodiment be omitted.

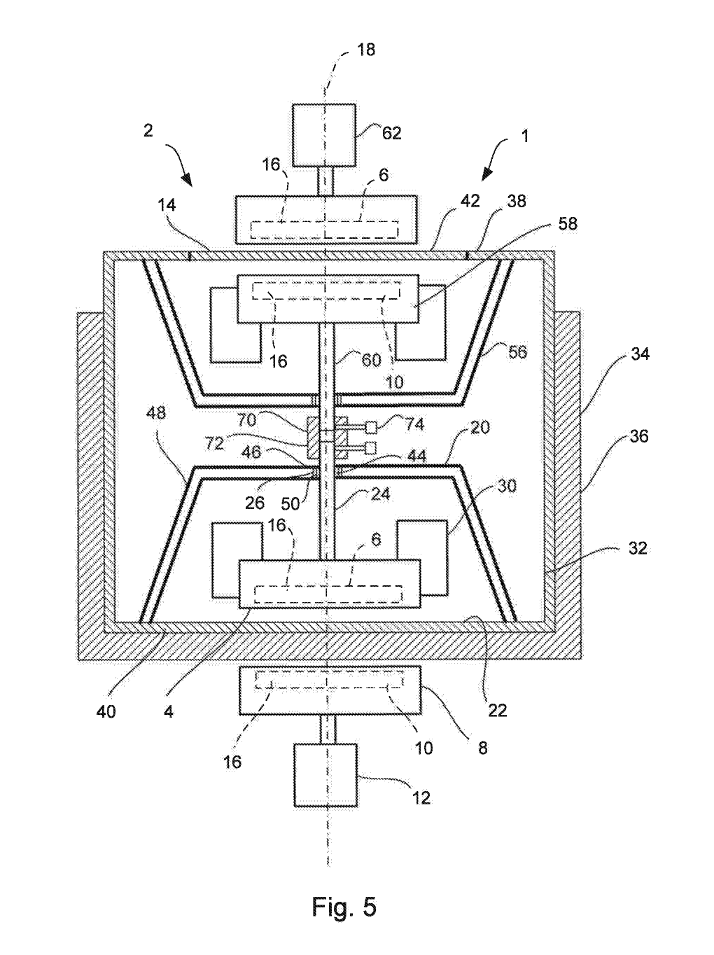

FIG. 5 shows a section view of a fourth embodiment of a magnetic agitator mixing system 1 according to the present invention. According to the fourth embodiment a further stand 56 provided with a third impeller 58 is arranged to rest on the inner surface 22 of the upper portion 38 of the container 14. The third impeller 58 is rotatably suspended in the further stand 56 by means of a second shaft 60, which is connected to the first shaft 24. A second motor 62 is connected to a second driving means 64 for rotating the third impeller 58 via a third and fourth magnetic coupling parts 66, 68. It is possible to rotate both the first and third impellers 4, 58 by means by the first motor 12, but the agitation and mixing effect will increase if the second motor 62 is arranged to rotate the third impeller 58 via the third and fourth magnetic coupling parts 66, 68. The first and second shafts 24, 60 may be connected by means of a connection piece 70 comprising a sleeve 72 and set bolts 74 allowing the shafts 24, 60 to be axially adjustable in order to adjust the total length of the first and second shafts 24, 60 in relation to the high of the container 14. The connection piece 70 may also be designed to allow the shafts 24, 60 to rotate individually with different rotation speeds, but fixating the shafts 24, 60 on a fixed axial distance in relation to each other. As a result the impellers 4, 58 arranged on the first and second shafts 24, 60 may have different dimensions and the shafts 24, 60 may be driven by different torque.

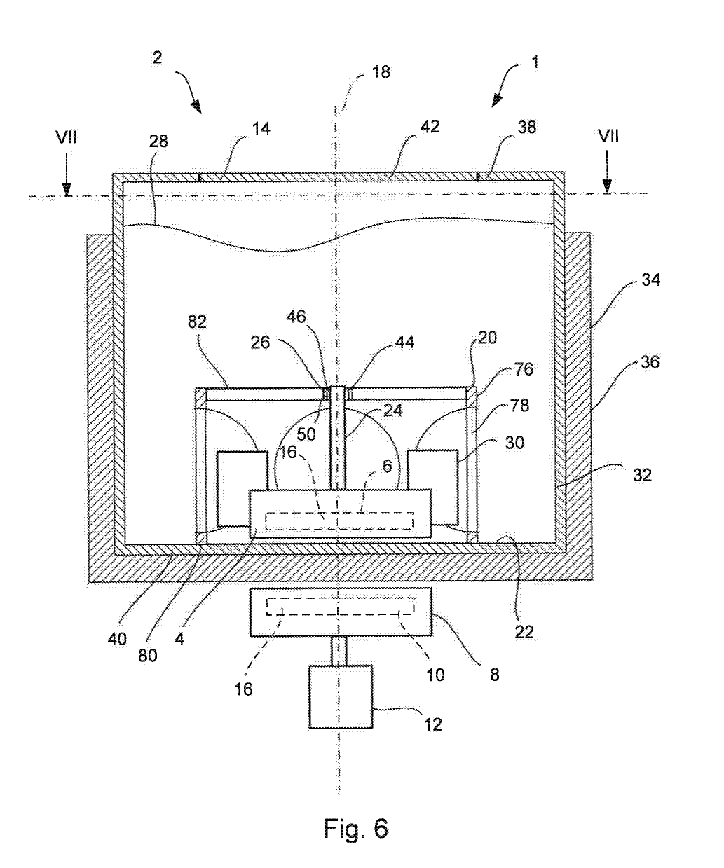

FIG. 6 shows a section view of a fifth embodiment of a magnetic agitator mixing system 1 according to the present invention. According to the fifth embodiment the stand 20 comprises a cylindrical wall element 76, which radially surrounds the first impeller 4. In an embodiment, the cylindrical wall element 76 is circular and the center axis 18 of the first impeller 4 and the first shaft 24 coincides substantially with the axis 18 of the circular wall element 76. When the first impeller 4 rotates fluid 28 will flow through perforations 78 in the wall element 76 and as a result the fluid 28 will be agitated and mixed by the first impeller 4. The cylindrical wall element 76 is provided with a rim 80, which rests on the inner surface 22 of the container 14. If the container 14 for some reason would be moved or be subjected for an external force the cylindrical wall element 76 will protect the container 14 from the first impeller 4 and prevent the first impeller 4 to slam into the wall 32 of the container 14.

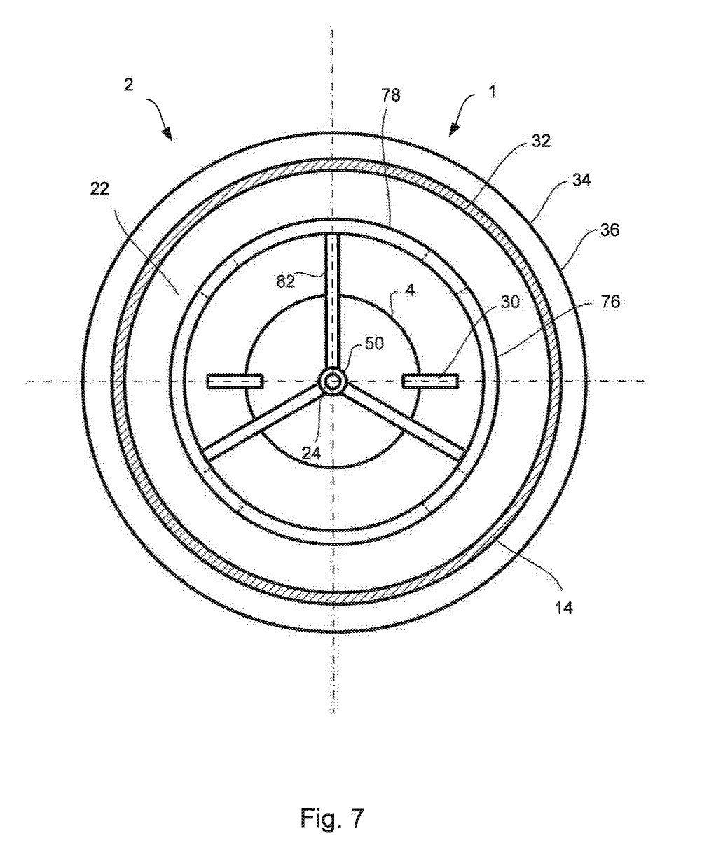

FIG. 7 shows a section view along line VII-VII in FIG. 6. From FIG. 7 it is evident that the stand 20 is substantially circular. However, other configurations of the cylindrical wall element 76 are also possible. The cylindrical wall element 76 is provided with spokes 82 connected to a central hub 50 in which the bearing 26 for the first shaft 24 is arranged.

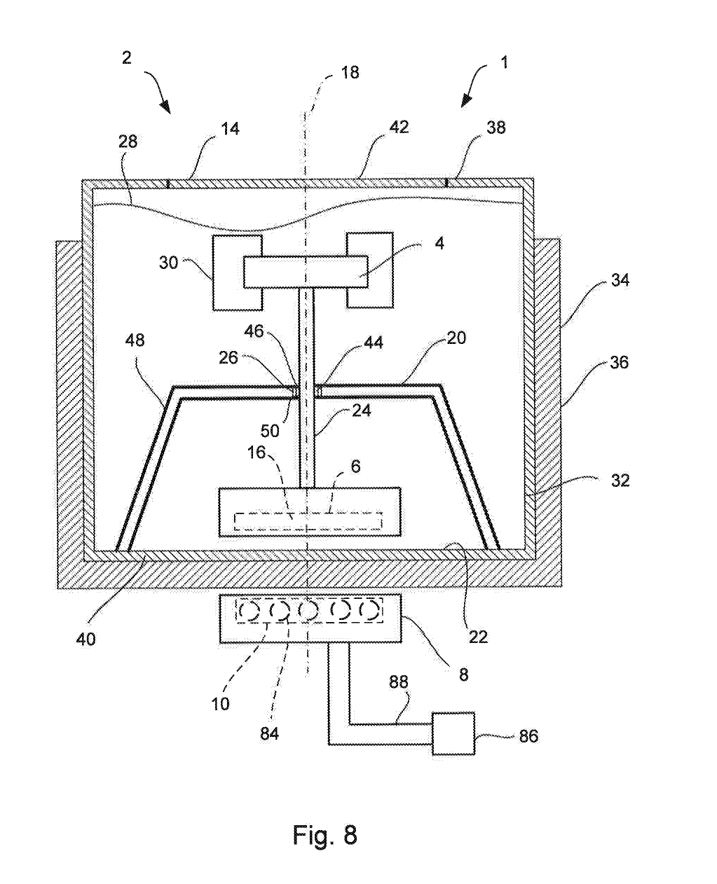

FIG. 8 shows a section view of a sixth embodiment of a magnetic agitator mixing system 1 according to the present invention. According to the fifth embodiment the second magnetic coupling part 10 is provided with a plurality of magnetic field generating, electrical coils 84 for rotating the the first magnetic coupling part 6 when generating a sequentially stepping magnetic field in a rotary motion. In an embodiment, the magnetic field generating, electrical coils are arranged in a circle in the first driving means 8. Switching pulses are generated in a control unit 86 for sequentially defining a plurality of discrete time periods linked through connection wires 88 to the electrical coils 84. During each of these time periods, a separate magnetic field is generated responsive to each switching pulse. The pulses are applied to the coils, in turn, for sequentially stepping a magnetic field in a rotary motion about the circle of coils. However, the coils may be arranged in a different geometry. The magnetic field generating, electrical coils 84 replace the electrical motors 12, 62 in the embodiments above. According to the sixth embodiment the first impeller 4 is arranged on the first shaft 24, which is connected to the first magnetic coupling part 6 and also connected to the stand 20 by means of a bearing 26.

In all embodiments described above parts and surfaces being in contact with a process fluid are suitably selected from materials that are in accordance with typical material requirements in (bio-)pharmaceutical manufacturing or food grade quality.

For example, materials are suitably in compliance with USP Class VI and 21 CFR 177. Furthermore they are suitably of animal-free origin and compliance to EMEA/41O/01.

Features and components of the different embodiments above may be combined within the scope of the invention.

What is claimed is:

1. A magnetic agitator mixing system comprising:
a first magnetic coupling part;
a first driver comprising a second magnetic coupling part; and
a container substantially enclosing the first magnetic coupling part, wherein the first magnetic coupling part is rotatably suspended in a stand arranged to rest on an inner surface of the container, and a first impeller in the first magnetic coupling part is arranged to be driven by the first magnetic coupling part.

2. The mixing system according to claim 1, wherein a first motor is connected to the first driver for rotating the first magnetic coupling part via the second magnetic coupling part.

3. The mixing system according to claim 1, wherein the second magnetic coupling part comprises a plurality of magnetic field generating electrical coils for rotating the first magnetic coupling part when generating a sequentially stepping magnetic field in a rotary motion.

4. The mixing system according to claim 1, wherein the first impeller is arranged on the first magnetic coupling part.

5. The mixing system according to claim 1, wherein the first magnetic coupling part and the first impeller are rotatably suspended in the stand by a first shaft.

6. The mixing system according to claim 5, wherein the first shaft is rotatably connected to the stand by a bearing.

7. The mixing system according to claim 5, wherein a second impeller is connected to the first shaft.

8. The mixing system according to claim 5, wherein the first shaft is rotatably connected to a further stand.

9. The mixing system according to claim 7, wherein a further stand, comprising a third impeller rotatably suspended in the further stand, is arranged to rest on the inner surface of the container.

10. The mixing system according to claim 9, wherein the third impeller is rotatably suspended in the further stand by second shaft connected to the first shaft.

11. The mixing system according to claim 10, wherein a second driver is connected to the second shaft for rotating the third impeller via third and fourth magnetic coupling parts.

12. The mixing system according to claim 1, wherein the stand comprises at least three legs arranged to rest on the inner surface of the container.

13. The mixing system according to claim 12, wherein the at least three legs comprises three legs arranged symmetrically as a tripod.

14. The mixing system according to claim 12, wherein the inner surface of the container comprises at least one receiver for fixating the at least three legs of the stand.

15. The mixing system according to claim 1, wherein the stand comprises a perforated cylindrical wall element radially surrounds the first magnetic coupling part.

16. An agitator mixing stand, comprising:
a first magnetic coupling part rotatably arranged at the stand,
wherein the first magnetic coupling part is rotatably suspended in the stand, and the stand is arranged to rest on an inner surface of a container.

17. The stand according to claim 16, further comprising at least three legs arranged to rest on the inner surface of the container.

18. The stand according to claim 17, wherein the at least three legs comprises three legs arranged symmetrically as a tripod.

19. The stand according to claim 16, further comprising a perforated cylindrical wall element radially surrounds the first magnetic coupling part.

20. The stand according to claim 16, wherein a first shaft is connected to the stand by a bearing, and the first magnetic coupling part is suspended on the first shaft.

21. The stand according to claim 20, wherein a first impeller is arranged on the first magnetic coupling part.

22. The stand according to claim 21, wherein a second impeller is arranged on the first shaft.
